(19) United States
(12) Patent Application Publication
(10) Pub. No.: US 2020/0408110 A1
(43) Pub. Date: Dec. 31, 2020

(54) CHARGING DEVICE

(71) Applicant: BMTS Technology GmbH & Co. KG, Stuttgart (DE)

(72) Inventors: Philipp Blasch, Stuttgart (DE); Oliver Kuhne, Stuttgart (DE); Anatolij Martens, Eislingen (DE)

(21) Appl. No.: 16/912,707

(22) Filed: Jun. 25, 2020

(30) Foreign Application Priority Data
Jun. 26, 2019 (DE) 102019209217.9

(51) Int. Cl. F01D 25/16; F16C 17/04

(52) U.S. Cl. CPC F01D 25/168; F16C 17/04; F05D 2240/50; F16C 2360/24; F05D 2220/40

(57) ABSTRACT

The invention relates to a charging device (1), in particular an exhaust gas turbocharger (2),
comprising a bearing housing (3) and a shaft (4) supported therein,
comprising an axial bearing disk (5) for supporting the shaft (4) in the axial direction (6).

It is essential for the invention thereby
that a receptacle (7) for the axial bearing disk (5) is provided, wherein the receptacle (7) has a single lug (9), which protrudes radially inwardly to an axis (8),
that the axial bearing disk (5) has an edge-side recess (10), which is formed complementary to the bearing housing-side lug (9),
that the lug (9) and the recess (10) are formed and/or aligned in such a way that they allow for only a single predefined installation position of the axial bearing disk (5) in the receptacle (7),

### CROSS-REFERENCE TO RELATED APPLICATIONS

This application claims priority to German Patent Application No. DE 10 2019 209 217.9, filed on Jun. 26, 2019, the contents of which is hereby incorporated by reference in its entirety.

### TECHNICAL FIELD

The present invention relates to a charging device, in particular an exhaust gas turbocharger, comprising a bearing housing and a shaft supported therein. The invention furthermore relates to an axial bearing disk for a charging device of this type.

### BACKGROUND

Axial bearing disks in charging devices serve for the purpose of axially supporting a shaft and thus for an interference-free operation of the charging device. In response to the assembly, axial bearing disks of this type are assembled so as to be secure against rotation in the bearing housing, wherein an unintentional incorrect installation is to be avoided at all costs.

A charging device comprising a bearing housing and a shaft supported therein is known from DE 1 155 942 B, wherein this shaft is supported in the axial direction via an axial bearing disk. The axial bearing disk is thereby fixed in a rotationally fixed manner in the bearing housing via a pin. It is disadvantageous thereby, however, that this pin has to be pressed into the bearing housing in a separate assembly step and moreover represents an additional component, which increases the number of parts.

A further charging device comprising a bearing housing is known from WO 2019/074936 A1, wherein a shaft of this charging device is likewise supported via an axial bearing disk. The axial bearing disk thereby has a pin, which is formed integrally with said axial bearing disk and which protrudes from a plane of the latter in the axial direction, and via which a fixation with respect to the bearing housing is possible. It is disadvantageous thereby, however, that an axial bearing disk of this type can no longer simply be re-ground in order to establish or ensure, respectively, the evenness of the axial bearing disk.

A further axial bearing disk is known from CN 20 24 18 233 U, which has edge-side recesses, which, on the one hand, usually serve as passage for the screws in order to fasten the bearing housing cover, and thus to fix the axial bearing disk, but, on the other hand, also serve as poka-yoke measure due to their arrangement, which his not symmetrical in the circumferential direction. In the case of a construction of this type, however, one is limited with respect to the reduction of the overall size, because the screws can only be fastened with difficulty in the case of small bearing housings, while, on the other hand, one is limited with respect to an even attachment of the bearing housing cover to the axial bearing disk and with respect to the oil core located in the bearing housing when positioning the screws.

A further charging device comprising a bearing housing and a supported shaft is known from JP H07-259847 A, wherein the shaft is supported in the axial direction via an axial bearing disk. On two opposite sides, the axial bearing disk thereby has two sections, which protrude in the radial direction and which can act as protection against rotation, but an incorrect assembly cannot be ruled out by means of an axial bearing disk of this type.

An axial bearing assembly for a shaft is known from DE 11 2013 001 938 T5, comprising a non-rotating axial bearing, several recessed or flush segments, which are distributed along the circumferential direction and which protrude from the axial bearing in the axial direction, and an stop collar, which is connected to the shaft in a rotationally fixed manner and which comprises a ring-shaped support surface for bearing on the segments of the axial bearing, wherein the segments are in each case limited by a first edge and a second edge, and a segment length is defined as curve length between the two edges in the circumferential direction.

### SUMMARY

The present invention deals with the problem of specifying an improved or at least an alternative embodiment for a charging device of the generic type, which in particular provides for a cost-efficient and easy to assembly axial bearing of a shaft.

This problem is solved according to the invention by means of the subject matter of the independent claim(s). Advantageous embodiments are the subject matter of the dependent claim(s).

The present invention is based on the general idea of equipping an axial bearing disk for supporting a shaft of a charging device in the axial direction with an edge-side lug or recess, which can be produced easily and which cooperates in such a way with a lug or recess arranged complementary thereto at a bearing housing that only a single predefined installation position in the manner of a poka-yoke system is possible. The charging device according to the invention, which can be formed, for example, as exhaust gas turbocharger, thereby has a bearing housing as well as a shaft supported therein, and the above-described axial bearing disk, via which the shaft can be supported in the axial direction. According to the invention, a receptacle for the axial bearing disk is now provided in the bearing housing, wherein the receptacle has a single lug, which protrudes inwardly to an axis of the axial bearing disk or of the shaft, respectively, in particular in the radial direction. The axial bearing disk, in turn, has an edge-side recess, which is formed complementary to the bearing housing-side lug and which protrudes outwardly, in particular in the radial direction, wherein the lug and the recess are formed or aligned with one another, respectively, in such a way that they allow for only a single predefined installation position of the axial bearing disk in the receptacle of the bearing housing. It goes without saying that, in the alternative, a single recess, which is directly outwardly from an axis of the axial bearing disk or of the shaft, respectively, in which the axial bearing disk engages with an edge-side lug formed complementary thereto and thus likewise allows for or even forces, respectively, only a single predefined installation position of the axial bearing disk in the receptacle of the bearing housing, can also be provided in the bearing housing-side receptacle. The only possible installation position can thereby be attained, for example, by means of a non-circular outer shape of the axial bearing disk comprising an edge-side recess or lug, wherein a recess or lug of this type can be arranged asymmetrically, for example with respect to a radial beam, and thus forces only a single possible installation position. The large advantage of a charging device of this type or of an axial bearing disk of this type, respectively, is that no further process steps, such as, for example, pressing in a securing pin, are not required and that the axial bearing disk can simultaneously be machined, for example ground, on both axial front side, because the protection against rotation is effected exclusively via an edge-side lug or recess, which does not protrude beyond an axial plane. Purely theoretically, a lug of this type or an edge-side recess of this type, respectively, at the axial bearing disk can effect any shape or a non-circular outer contour of the axial bearing disk, which has to only be aligned or formed, respectively, in such a way that the axial bearing disk can be received in the receptacle of the bearing housing at a predefined angular position and with a predefined front side. A poka-yoke system is thus provided with the charging device according to the invention, which reliably rules out an incorrect assembly, provides for a problem-free machining of the axial bearing disk on both front surfaces, and which simultaneously makes further process steps for fixing the axial bearing disk in the receptacle unnecessary, whereby a cost-efficient production of the axial bearing is possible as a whole. Due to the elimination of the securing pin, which has previously been required, for example, the number of parts can moreover be reduced and thus the storage and logistics costs associated therewith.

It goes without saying that it is clear thereby that the lug at the axial bearing disk is dimensioned in such a way that it cannot engage with an oil drain, which may be present in the area of the receptacle, and that this may lead to the possibility of an incorrect assembly.

In the case of an advantageous further development of the charging device according to the invention, the recess has an axial thickness D_{A} and the lug has an axial thickness D_{N}, which are smaller than the axial thickness D of the axial bearing disk. This means that the axial bearing disk has a completely continuous surface on at least one axial front surface. Due to a design of this type it absolutely required to insert the axial bearing disk into the bearing housing-side recess in such a way that the axial bearing disk-side recess is arranged such that it comes to rest on the bearing housing-side lug. If the axial bearing disk is inserted in the receptacle, for example rotated by 180°, the axial bearing disk-side recess would not come to rest on top of the bearing housing-side lug, and the axial bearing disk would come to rest at an incline in the receptacle, which prevents, e.g. an insertion of the shaft or the fastening of the bearing housing cover.

The recess and the lug are advantageously arranged symmetrically with respect to a radial. In the case of the embodiment, in the case of which the recess does not completely penetrate the axial bearing disk, this is already sufficient to force a predefined installation position, so that an asymmetrical arrangement of the recess with respect to a radial can be forgone. It goes without saying that it is also conceivable that, in addition to a recess, which is only formed as groove, an asymmetrical arrangement of the recess or of the lug, which is on the bearing housing-side in this case, is also realized in the axial bearing disk.

In the case of a further advantageous embodiment of the solution according to the invention, the recess has an axial thickness D_{A}, which is identical to the axial thickness D of the axial bearing disk, so that the recess completely penetrates the axial bearing disk. The lug, which is on the bearing housing side in this case, then has an axial thickness D_{N}, which is either smaller than or maximally identical to the axial thickness D of the axial bearing disk. The recess resp. the lug would need to be arranged asymmetrically with respect to a radial in this case, in order to force a predefined installation position. Due to a corresponding formation or alignment, respectively, or arrangement of the axial bearing disk-side recess or lug, respectively, and the bearing housing-side lug or recess, respectively, which is formed complementary thereto, it is not only possible to create a so-called poka-yoke system, but also a key and lock system, which forces the insertion of an authorized axial bearing disk when replacing the axial bearing disk in the case of maintenance, in order to even provide for a reliable axial support of the shaft at all. Due to the use of a key and lock system of this type, the use of authorized and thus of high-quality and long-lasting axial bearing disks can thus be ensured.

The axial bearing disk is advantageously formed as punched part. Compared to previous axial bearing disks, for example comprising a pin protruding from the axial front side, the axial bearing disk according to the invention can be produced comparatively easily and thus cost-efficiently, but also with an extremely high quality. For this purpose, the axial bearing disk is punched either with the axial bearing disk-side lug or the axial bearing disk-side recess by means of a corresponding punching tool and is subsequently also machined on both front sides, for example ground. Purely theoretically, a further shaping is not required. It goes without saying that it is conceivable thereby that two or more lugs or recesses of this type, respectively, are also provided at the axial bearing disk or that corresponding lugs or recesses, respectively, are provided at the corresponding bearing housing, respectively, in order to further refine the key and lock system.

The present invention is further based on the general idea of specifying an axial bearing disk of the above-described charging device, which has an edge-side recess or an edge-side lug. With the lug or the recess, respectively, an axial bearing disk of this type thus offers a key, which forms the above-described key and lock system with the corresponding lug or recess, respectively, in the receptacle of the bearing housing. It goes without saying that the embodiments of the axial bearing disk described in this way can analogously not only be transferred to the entire system of the charging device comprising axial bearing disk, but also to the axial bearing disk alone.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations or alone, without leaving the scope of the present invention.

Preferred exemplary embodiments of the invention are illustrated in the drawings and will be described in more detail in the following description, whereby identical reference numerals refer to identical or similar or functionally identical components.

### BRIEF DESCRIPTION OF THE DRAWINGS

In each case schematically,

FIG. 1 shows a view onto a charging device according to the invention in the area of a receptacle for an axial bearing disk according to a first embodiment,

FIG. 2 shows a sectional illustration along the sectional plane A-A through the charging device according to FIG. 1 with inserted axial bearing disk,

FIG. 3 shows an illustration of the asymmetry of the bearing housing-side lug to a radial,

FIG. 4 shows an illustration as in FIG. 1, but with a bearing housing-side lug of a smaller axial thickness,

FIG. 5 shows a sectional illustration along the sectional plane B-B from FIG. 4 with a first embodiment of an axial bearing disk,

FIG. 6 shows an illustration as in FIG. 5, but with a second embodiment of an axial bearing disk,

FIG. 7 shows a diagram to clarify the symmetry of a lug or of a recess, respectively, to a radial,

FIG. 8 shows an axial bearing disk according to the invention with a nose arranged at the edge side,

FIG. 9 shows an illustration as in FIG. 8, but from the rear side.

### DETAILED DESCRIPTION

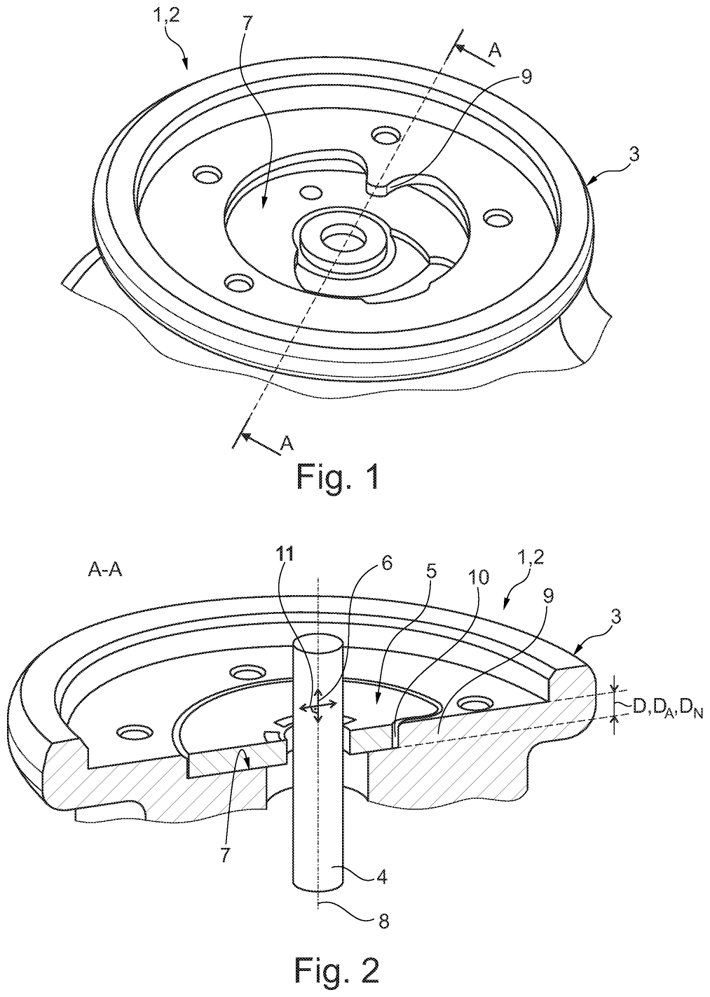

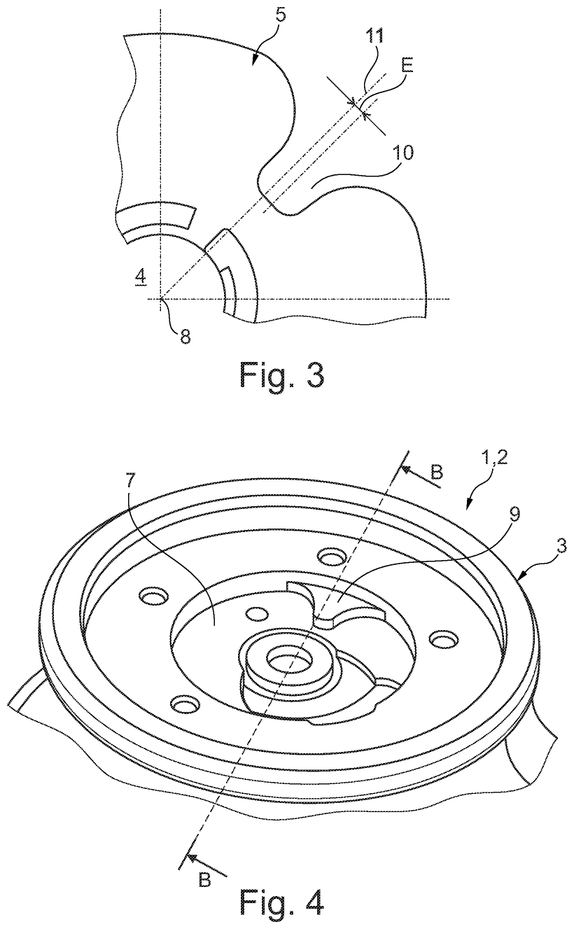

According to FIGS. 1, 2 as well as 4 to 6, a charging device 1 according to the invention, which can be formed, for example, as exhaust gas turbocharger 2, has a bearing housing 3 as well as a shaft 4, which is supported therein and which is illustrated only schematically. An axial bearing disk 5 (see also FIGS. 3 as well as 7 to 9) for supporting the shaft 4 in the axial direction 6 is likewise provided. A receptacle 7 for the axial bearing disk 5 is thereby provided in the bearing housing 3, wherein the receptacle 7 has a single lug 9 protruding inwardly to an axis 8, while the axial bearing disk 5 has an edge-side recess 10, which is formed complementary to the bearing housing-side lug 9. The lug 9 and the recess 10 are thereby formed and/or aligned in such a way that they allow only a single, namely predefined installation position of the axial bearing disk 5 in the receptacle 7 of the bearing housing 3. It goes without saying that, in reversed form, it can also be provided according to the invention that the receptacle 7 has only a single recess (not shown), which is directed outwardly from an axis 9, while the axial bearing disk 5 has an edge-side lug 9′, which is formed complementary to the bearing housing-side recess, as it is shown, for example, according to FIGS. 8 and 9. In this case, the lug 9′ and the non-illustrated bearing housing-side recess are also formed or aligned with one another, respectively, in such a way that they allow only a single predefined installation position of the axial bearing disk 5 in the receptacle 7 of the bearing housing 3 and thus in particular rule out an incorrect assembly.

A “single predefined installation position” is to thereby mean that there is in fact only and exclusively a single installation position, so that the axial bearing disk 5 can only assume the installation position when it is installed correctly with respect to the rotational angle position and correct with respect to the front sides.

In particular a so-called poka-yoke system, which rules out an incorrect assembly of the axial bearing disk 5 in the bearing housing 3, can be created by means of such a charging device 1 according to the invention. The axial bearing disk 5 and the corresponding receptacle 7, that is concretely, the lug 9, 9′ or a corresponding recess 10, respectively, thereby also form a key and lock system, which ensures the use of authorized axial bearing disks 5 and thus provides for a long-term optimal storage of the shaft 4 in the axial direction 6.

When now looking at the individual embodiments of the charging device 1 according to the invention or also of the axial bearing disk 5 according to the invention, respectively, it can be seen in the case of the embodiments according to FIGS. 1 to 3 that the recess 10 in the area of the axial bearing disk 5 has an axial thickness D_{A}, which is identical to the axial thickness D of the axial bearing disk 5. The lug 9 thereby has an axial thickness D_{N}, which is likewise identical to the thickness D of the axial bearing disk 5, wherein the lug 9 or the recess 10, respectively, are arranged asymmetrically to a radial 11 in this case for only a single predefined installation position, that is, e.g., with a certain eccentricity E, as it is illustrated according to FIG. 3. Due to this asymmetry or eccentric arrangement of the lug 9, respectively, or of the recess 10, respectively, with respect to the radial 11, a mix-up of the front sides of the axial bearing disk 5 can be ruled out when installing the latter into the receptacle 7. As alternative to an eccentricity E, an incline of a central axis of the lug 9 with respect to the radial 11 or another lug 9, which is not designed mirror-symmetrically with respect to the radial 11, is also conceivable.

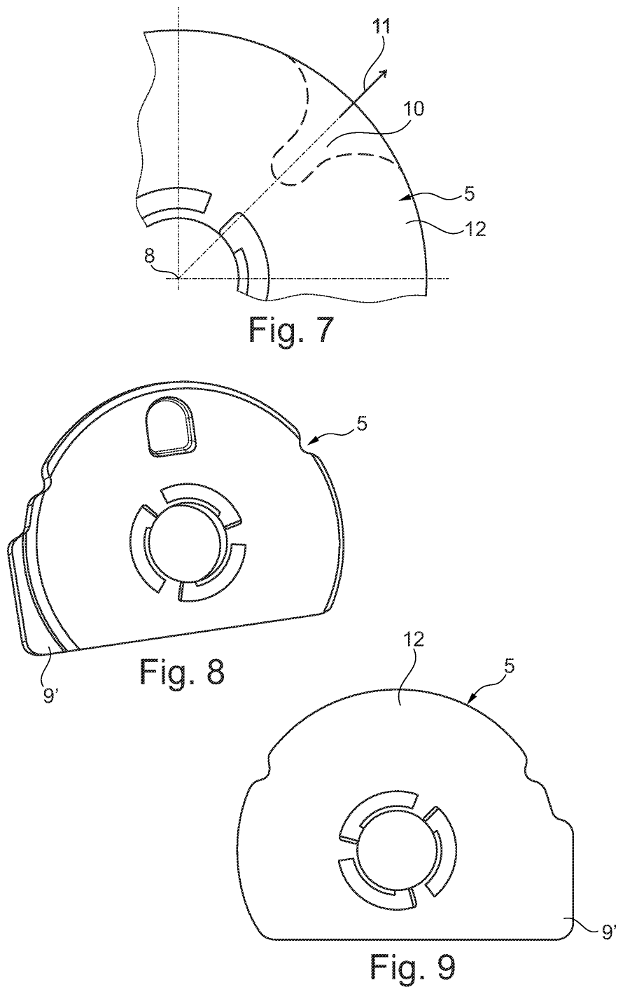

When looking at the embodiments of the charging device 1 according to the invention or of the axial bearing disk 5 according to the invention, respectively, according to FIGS. 4 to 9, it can be seen that the recess 10 has an axial thickness D_{A} and/or that the lug 9 has an axial thickness D_{N}, which are smaller than the axial thickness D of the axial bearing disk 5. The axial thickness D_{A} of the recess 10 can, for example, be identical to the axial thickness D_{N} of the lug 9, wherein both of them together correspond to the thickness D of the axial bearing disk 5. An embodiment of this type is shown, for example, in FIG. 6. A special case of this embodiment can be at hand, for example, when the following applies: D_{A}=D_{N}=0.5 D. An embodiment of this type offers the large advantage that the recess 10 is not continuous in the axial bearing disk 5, so that it has a continuous surface 12 on the side facing the shaft 4. Due to the recess 10, which is provided only on a single front side, namely on the front side located opposite the continuous surface 12, an incorrect assembly in the receptacle 7 of the bearing housing 3 or of a bearing housing cover, respectively, can likewise be avoided. If the axial thickness D_{A} of the recess 10 in the axial bearing disk 5 is smaller than the entire axial thickness D of the axial bearing disk 5, the recess 10 can also be arranged symmetrically to the radial 11, as it is illustrated according to FIG. 7, because an incorrect assembly is already ruled out due to the non-continuous recess 10.

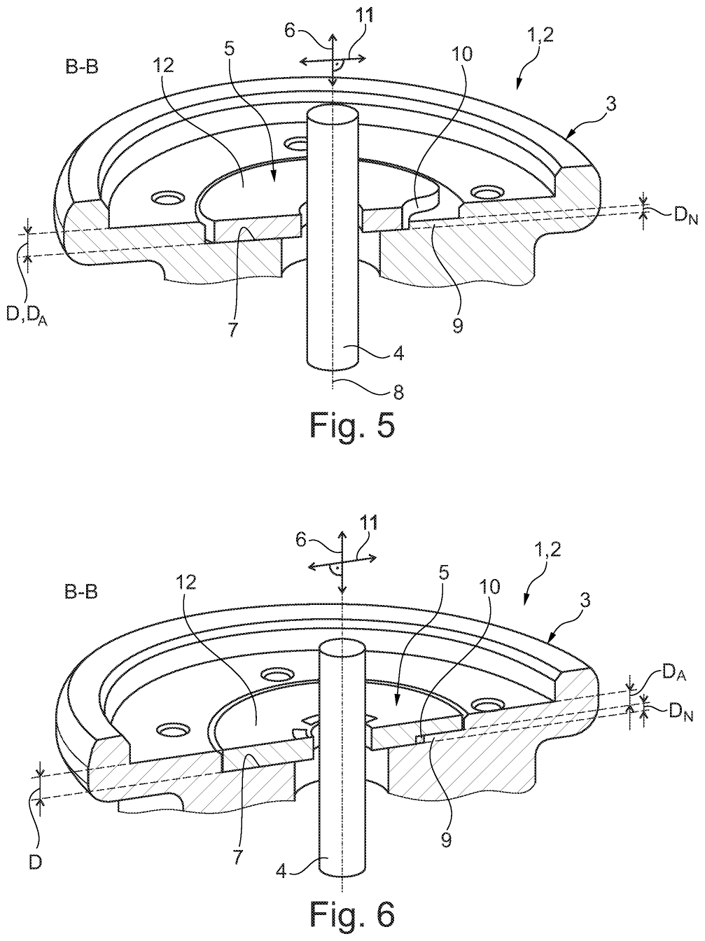

It goes without saying that it is also conceivable thereby that the axial thickness D_{N} of the lug 9 is smaller than the axial thickness D of the axial bearing disk 5, as it is illustrated according to FIG. 5, wherein, in the case of the axial bearing disk 5 illustrated there, the recess 10 has an axial thickness D_{A}, which corresponds to the axial thickness D of the axial bearing disk 5. It would be irrelevant in this case, whether the recess 10 is formed symmetrically or asymmetrically to a radial 11, which runs orthogonally to the axis 8, provided that the axial bearing disk 5 has for example two identical surfaces 12, which in each case provides for a support.

The axial bearing disk 5 is preferably formed as simple punched part and can thus be produced not only cost-efficiently, but also with a high quality.

When looking at the axial bearing disks 5 according to FIGS. 8 and 9, it can be seen that, in contrast to the above-shown axial bearing disks 5, they have a lug 9′ protruding outwardly on the edge-side, wherein the receptacle 7 of the bearing housing 3 would need to have a corresponding, complementary recess in this case, in order to thus ensure an unambiguously predefined installation position. The lug 9′ advantageously provides for a surface 12, which is continuous with respect to the surface 12, so that the surface 12 is not interrupted by the recess 10 in this case, because the latter is provided in the area of the receptacle 7 of the bearing housing 3. It goes without saying that the statements made with regard to the axial bearing disk 5 having the recess 10, and the statements made with regard to the lug 9 of the receptacle 7, apply analogously to the reversed form, in the case of which the lug 9′ is arranged at the axial bearing disk 5, while the recess 10 is arranged in the area of the receptacle 7 of the bearing housing 3. The continuous surfaces 12 provide the large advantage that they can be machined significantly more easily, in particular as compared to the pins protruding axially from the surface 12, which had previously been used for the protection against rotation and fixation of the axial bearing disk 5.

A simple and cost-efficient production in particular of the axial bearing disk 5, namely preferably as simple punched part, can be ensured by means of the charging device 1 according to the invention and by means of the axial bearing disk 5 according to the invention, wherein an incorrect assembly can simultaneously be ruled out. Due to the poka-yoke system, an installation of the axial bearing disk 5 in the receptacle 7 of the bearing housing 3 can even be performed by an untrained worker.

A key and lock system, which ensures the use of authorized and thus high-quality axial bearing disks 5, can furthermore be formed via a special design of the lug 9 or of the corresponding recess 10, respectively. Compared to a securing pin, which had previously been used, for example, for the protection against rotation of the axial bearing disks, the axial bearing disk 5 according to the invention and the charging device 1 according to the invention can forgo a safety pin of this type, whereby not only the assembly costs, but additionally also the number of parts and, associated therewith, the storage and logistics costs, can be lowered.

1. A charging device, comprising:
a bearing housing and a shaft supported therein;
an axial bearing disk supporting the shaft in an axial direction;
the bearing housing including a receptacle structured and arranged to receive the axial bearing disk;
the receptacle including one of (i) a single lug that protrudes radially relative to an axis of the shaft and (ii) a single recess that opens radially relative to the axis of the shaft;
the axial bearing disk including the other one of (i) the lug and (ii) the recess;
wherein the recess is configured complementary to the lug; and
wherein the lug and the recess are structured and arranged such that the axial bearing disk is installable within the receptacle only in a single predefined installation position of the axial bearing disk.

2. The charging device according to claim 1, wherein the recess has an axial thickness and the lug has an axial thickness that are smaller than an axial thickness of the axial bearing disk.

3. The charging device according to claim 2, wherein the axial thickness of the recess and the axial thickness of the lug are equal to half the axial thickness of the axial bearing disk.

4. The charging device according to claim 1, wherein the recess and the lug are symmetrical with respect to a radial direction of the shaft.

5. The charging device according to claim 1, wherein:
the recess has an axial thickness identical to an axial thickness of the axial bearing disk;
the lug has an axial thickness that is smaller than the axial thickness of the axial bearing disk; and
the recess and the lug are asymmetrical with respect to a radial direction of the shaft.

6. The charging device according to claim 1, wherein:
the recess has an axial thickness and the lug has an axial thickness that are identical to an axial thickness of the axial bearing disk; and
the recess and the lug are asymmetrical with respect to a radial direction of the shaft.

7. The charging device according to claim 1, wherein the axial bearing disk is a punched axial bearing disk.

8. An axial bearing disk of a charging device, comprising a disk body having an outer edge side, the disk body including one of:
a recess disposed at the outer edge side and extending into the disk body radially inwardly; and
a lug protruding radially outwardly from the outer edge side.

9. The axial bearing disk according to claim 8, wherein the disk body includes the recess, and the recess has an axial thickness that is smaller than an axial thickness of the disk body.

10. The axial bearing disk according to claim 9, wherein the axial thickness of the recess is equal to half the axial thickness of the disk body.

11. The axial bearing disk according to claim 8, wherein the disk body includes the recess, and the recess has an axial thickness that is identical to an axial thickness of the disk body.

12. The axial bearing disk according to claim 8, wherein the disk body includes the lug, and the lug has an axial thickness that is smaller than an axial thickness of the disk body.

13. The axial bearing disk according to claim 8, wherein the disk body includes the lug, and the lug has an axial thickness that is identical to an axial thickness of the disk body.

14. The axial bearing disk according to claim 8, wherein the axial bearing disk is structured as a punched component.

15. The charging device according to claim 1, wherein:
the receptacle includes the recess and the axial bearing disk includes the lug;
the lug protrudes radially outward from an outer edge of the axial bearing disk; and
the recess protrudes radially into the bearing housing from an edge of the receptacle.

16. The charging device according to claim 1, wherein:
the receptacle includes the lug and the axial bearing disk includes the recess;
the lug protrudes radially into the receptacle from an edge of the receptacle; and
the recess protrudes radially into the axial bearing disk from an outer edge of the axial bearing disk.

17. The charging device according to claim 16, wherein the lug is defined by a portion of the bearing housing.

18. The charging device according to claim 17, wherein a radially inward facing surface of the lug merges into a radially inward facing surface of the receptacle.

19. The charging device according to claim 16, wherein the recess is defined at least partially by an outer circumferential surface of the axial bearing disk.

20. A charging device, comprising:
a bearing housing;
a shaft including a shaft axis supported within the bearing housing;
an axial bearing disk axially supporting the shaft, the axial bearing disk including an axial opening through which the shaft extends;
the bearing housing including a receptacle structured and arranged to receive the axial bearing disk;
the receptacle including one of a (i) a lug that protrudes radially relative to the shaft axis and (ii) a recess that opens radially relative to the shaft axis;
the axial bearing disk further including the other one of (i) the lug and (ii) the recess;
wherein the recess and the lug are structured complementary to one another; and
wherein the lug and the recess are structured and arranged to form a key and lock system where the axial bearing disk is installable within the receptacle exclusively in a predefined installation position of the axial bearing disk.
